(19) United States
(12) Patent Application Publication
(10) Pub. No.: US 2024/0403761 A1
(43) Pub. Date: Dec. 5, 2024

(54) FENCE INDUSTRY ESTIMATING AND PROJECT MANAGEMENT SYSTEM

(71) Applicant: Dan Turbeville, Munford, TN (US)

(72) Inventor: Dan Turbeville, Munford, TN (US)

(21) Appl. No.: 18/593,852

(22) Filed: Mar. 1, 2024

Related U.S. Application Data
(60) Provisional application No. 63/449,057, filed on Mar. 1, 2023.

(51) Int. Cl. G06Q 10/0631; G06Q 30/0601; G06Q 50/08

(52) U.S. Cl. CPC G06Q 10/06315; G06Q 30/0635; G06Q 50/08

(57) ABSTRACT

Disclosed herein is an estimating and project management method and system built specifically for the fence industry. Its capabilities include chain link, wood, ornamental, vinyl, concrete, agricultural, and any other type of fence, allowing users a fully customizable solution for material calculations and cost. The disclosed system includes products, calculations, configurations and inventory items in a single platform to facilitate design, planning, and purchasing for fence businesses and builders. Such a system further permits users the ability to add or remove items (selections, products, designs, etc.) to and from the system on demand to tailor such a system and method to their individual or entity-wide business needs. The disclosed system additionally permits users to upload plans, specifications, satellite images, and scanned documents, as well as to create blank virtual workspaces in support of such a facilitated fence generating and building platform.

### CROSS-REFERENCE TO RELATED APPLICATION

This application claims priority to co-pending U.S. Provisional Patent Application No. 63/449,057, filed Mar. 1, 2023, the entirety of which is herein incorporated by reference.

### FIELD OF THE DISCLOSURE

Disclosed herein is an estimating and project management method and system built specifically for the fence industry. Its capabilities include chain link, wood, ornamental, vinyl, concrete, agricultural, and any other type of fence, allowing users a fully customizable solution for material calculations and cost. The disclosed system includes products, calculations, configurations and inventory items in a single platform to facilitate design, planning, and purchasing for fence businesses and builders. Such a system further permits users the ability to add or remove items (selections, products, designs, etc.) to and from the system on demand to tailor such a system and method to their individual or entity-wide business needs. The disclosed system additionally permits users to upload plans, specifications, satellite images, and scanned documents, as well as to create blank virtual workspaces in support of such a facilitated fence generating and building platform.

### BACKGROUND OF THE PRIOR ART

Certain systems have been provided in the past to allow for building plans (blueprints, and the like), as well as certain landscaping capabilities and fence erection activities. As it pertains to such fence programs and methods, however, there are noticeable limitations and, as a result, deficiencies that impede efficient operations. For instance, prior fence design systems are limited in terms of the types of configurations available for graphic interface capabilities. Other systems fail to provide full conceptual capabilities for the full fence designs permitted and, for the most part, needed, for complete fence building and materials purchasing considerations. In other words, such prior fence design systems fail to account for every permutation of materials needed and/or desired for a complete production operation. Without such a full capability, such prior systems require the utilization of more than one planning system, ostensibly, to accomplish such a goal, thereby burdening the fence business operator to acquire or license multiple computerized products in order to achieve a bare minimum of operations for customer acceptance. As a result, there is a need to provide a full complement of needed fencing article designs, material understanding and incorporation within such designs, and coordination overall for material ordering and purchasing for fence business operators within a single platform. To date, such possibilities are simply unavailable within the fence industry.

### ADVANTAGES AND SUMMARY OF THE DISCLOSURE

The disclosure provides, as one notable advantage, a software-based single platform for a full fence design and production system, including complete materials selection, purchasing, and ordering capabilities. In comparison with such prior systems noted above, as another advantage, the entirety of such a method and system to provide such overarching processes through a single access point has heretofore been nonexistent within the fencing industry.

As an overview, with such a software platform, users may upload any documents related to a fence design and manufacture project. Work orders, shop drawings, submittals, contracts, etc., may be uploaded to individual jobs saved in the software program (which may be individualized) to be used for project management. Users may draw fence lines and set specifications which the software system converts to calculate a material list with costs for the overall project, as well. All of these procedures are accomplished within a cloud-based software system accessible through any web browser on any computerized device. Furthermore, the disclosed fencing design and manufacturing project system and method includes various pricing options that provide different levels of access for potential users on demand to any degree.

Accordingly, this disclosure encompasses a process, comprising: A fence construction estimation and planning process, comprising:

providing a computer processor including a specific program related to fence construction estimation and planning;

providing, within said computer processor program, an aerial view base plan for a parcel of land for placement of a fence on a computer screen by a user;

superimposing, within said computer processor program. a representation of a fence structure on said base plan with the ability to maneuver such a representation through a computerized function by said user to a different representation configuration as necessary;

generating a take-off plan within said computer processor program associated with said representation of said fence structure, including specific material requirements associated with said fence structure from a computer-based menu thereof, wherein said material requirements relate at least to structural components, dimensional requirements, and custom selections thereof on demand;

providing a user the ability to change any specific materials related thereto on demand within said computer processor program; and

correlating said specific material requirements to an order of such materials for delivery to said user for said fence construction through utilization of said computer processor program.

In greater detail, the following is presented:

### Projects

The first step for any job within the disclosed system and method is to create a “Project.” Once projects are created, one may then assign a bid date which is then utilized as a basis for estimating calendar dates for the project. Projects are then organized on a calendar according to such bid date or dates. Users may then assign a status to projects such as “bidding,” “sold,” “completed,” etc. A user may also assign a customer's name to projects if so desired (or any other identifying label). Projects may then be filtered by status and company name to make the projects easy to find and well organized.

### Plans

Thereafter, plans may be created using blueprints, satellite imagery, hand drawings, and/or PDFs. In addition to uploading plans, users may create a “grid plan” which is a virtual drawing board if no plans are available. Any of these files may be used to create takeoffs as outlined below in greater detail. Users may create plan sets where drawings (blueprints) are uploaded and users may further organize each project and plan by creating folders within plan sets. Each plan set, folder and document may be given a unique name to make them easily locatable within the project file, as well. Drawings may also be bookmarked, allowing an additional folder to be created (under a “Bookmarks” heading, possibly) which may contain a shortcut to any such bookmarked drawings. Drawings may be further provided in rotatable status to permit desired, if not proper, orientation. Once plans are uploaded, users set a scale (length of measurement) and draw fence lines directly on the plans. As plans are uploaded, the software system scans the text which allows users to search for keywords throughout the plan set.

### Documents

Users may upload anything related to the project within a document section. Such documents may be viewed and downloaded from the disclosed system and method for future use. Examples of documents uploadable within this system and method include specifications, proposals, material quotes, contracts, shop drawings, submittals, and any other PDF file associated with the project.

### Take-Offs

Once a drawing or grid plan is prepared, a user may then create a take-off. A take-off is essentially drawings on a plan that the disclosed system and method uses to calculate material lists and costs. When the user draws on plans, the system defines end posts, corner posts, gate posts, existing posts, fence lines, and gates associated within the overall fence design project. All of these components are used in the calculations for material quantities and costs.

The disclosed system and method are programmed in a way to understand how fence lines interact with each post type. For example, the software is programmed to understand and know if a certain post type has one, two, or three, etc., hookups; such hookup calculations are required to generate an overall accurate material list. Such a feature is lacking within any prior software systems in this industry, thus making the disclosed software system and method quite unique in the fence manufacturing and design software world. Without such a distinct feature, the disclosed system software could not accurately generate material lists for fence design and manufacturing business customers.

One project can contain multiple take-offs which results in a material list per take-off. One take-off may also be used across multiple plan pages or drawings and combined on one material list. Specifications are assigned by the user per project or using preset configurations, multiple specifications may be utilized within a single project describing multiple types of fence and gates. Such versatility within the entirety of the disclosed system and method thus accords the necessary and heretofore unexplored degree of capabilities for full fence design, materials purchasing, and manufacturing for such business customers.

Additionally, users have the ability to override the measured length on any drawing to suit their needs. For example, an actual field measurement may vary from those within the plan. A user can simply click on the line and adjust the length. When the measurement is corrected, the system and method allow for adjustments of the target material list accordingly.

### Products/Components

The disclosed system and method will further include several products when a new user subscribes to the software program providing such capabilities. These products are included to serve as a model for how a user may create their own individualized sub-programs within the overarching system itself. Each component has unique calculations which are used to generate the material list. Users can modify existing calculations or add their own on demand. Product quantities may be calculated using conditional formulas which are triggered by user selections such as adding components or choosing certain options (and even taking into consideration possible extra products if production mistakes occur during fence erection). Options can be automatically selected or rejected through the utilization of validators or restrictions. Validators are similar to conditional calculations; however, such a procedure permits a specific option to be chosen when certain conditions are met. Restrictions do not allow certain options to be selected if a prior selection is incompatible. Thus, as an example, if a user selects component “A” which requires component “B,” the disclosed system and method automatically adds component “B.” The inverse is also true with incompatible components. If component “A” and “B” are incompatible, the software will not add both within the same project.

Users may thus be permitted to define all options or material specifications wanted or needed for inclusion within the disclosed system and method. Each user (individual or entity) may customize the disclosed system and method to their standards or specific project requirements, as well.

Each gate is its own sub-product with a unique list of components, options, specifications, validators, restrictions, required and incompatible components. Gate components can be tied to the parent product (selected options) or stand alone. User companies may add, remove, or modify all components, options, specifications, etc., noted above on demand, as well.

Products and sub products (gates) may further be cloned or duplicated as a shortcut to create additional products or sub products within the disclosed system and method, as well.

A dynamic name may then be generated for each product defining its description on a material list. A dynamic name is comprised of options selected by the user. Any changes to the selected options will dynamically change the name in the material list for full identification purposes.

The fence material products are then generally calculated in relation to dimensions (length, width, depth, as examples) or with regard to quantitative amounts (as per component part, for instance). When using dimensional measurements (length, for example), users may then define packages as set by vendors or inventory in relation thereto. The disclosed system and method then allows for calculations of quantity and length per item in such situations (or in relation, again, to other dimensional considerations). The system and method then may determine which package length to use to maximize utilization and minimize loss during the overall manufacturing project. Thus, in one potentially preferred embodiment, a generated material list for items sold in quantity and dimensionally (length, again, for instance), includes dynamic name, length per piece, quantity of packages required, and total length of material required. For example, if three (3) eight-foot (8′) pieces are required, the disclosed system and method will calculate one (1) 24′ length (package).

### Product Configurations

A product configuration within the disclosed system and method is a predetermined list of options as set by the user company. These configurations may be the company's standards or specifications required for a specific project. The disclosed system and method will include preset product configurations. Again, these included configurations are to serve as an example of how the system functions. Each user may modify each project under the overall software system and method herein to suit their needs. When creating a take-off, users may be able to select these configurations to drastically reduce the set-up time required for each fence type targeted for manufacturing under the disclosed system and method.

Product configurations may also be cloned to expedite the process of creating additional configurations for each user, as well. Also, when creating a take-off, a product configuration may be cloned to allow users to make small modifications to existing product configurations, too. Again, such versatility allows for a complete and overarching capability for a user that has heretofore been missing within the fence design and manufacturing industry.

### Inventory

Users create inventory, or stock items, based on available options for each material product. A cost is assigned to each inventory item at least when created within the disclosed system and method. When a material list is generated, the software matches options with available inventory items to assign a cost. As noted above, inventory items may be created for items sold in length or piece quantities. Again, users may add, remove, or modify inventory items as they see fit.

### Material List

A key component of the disclosed system and method is to easily generate material lists and material costs. When material lists are generated, every component may show on the material list as defined by each user. As alluded to above, at least, users may add, remove, or modify items in the material list. In addition, users may adjust quantities and costs directly on the material list.

The material list may also be exported as a PDF or CSV file, at least, within the overall disclosed system and method.

Material lists may thus include a user's project name, user's (individual or company, for instance) name, and customer name along with material and cost described above.

In an example embodiment, components/modules of the fence structure estimation system can be implemented using standard programming techniques. For example, the fence structure estimation system may be implemented as a “native” executable running on the CPU, along with one or more static or dynamic libraries, particularly as it pertains to the specific materials available for such fence construction, as well as for purchase after such materials are fully determined and decided for actual construction by a user. In general, a range of programming languages known in the art may be employed for implementing such example embodiments, including representative implementations of various programming language paradigms, including but not limited to, object-oriented languages (e.g., Java, C++, C#, Matlab, Visual Basic.NET, Smalltalk, and the like), functional languages (e.g., ML, Lisp, Scheme, and the like), procedural languages (e.g., C, Pascal, Ada, Modula, and the like), scripting languages (e.g., Perl, Ruby, Python, JavaScript, VBScript, and the like), and declarative languages (e.g., SQL, Prolog, and the like). Portions of the fence structure estimation and management (planning) system, including the fence materials computation and determination engine, may simply be implemented as files or macros within a spreadsheet processing program such as, for example, Microsoft Excel™.

The embodiments described above may also use well-known synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments execute concurrently and asynchronously and communicate using message passing techniques. Also, other functions could be implemented and/or performed by each component/module, and in different orders, and by different components/modules, yet still achieve the functions of the fence structure estimation and management system herein disclosed.

In addition, programming interfaces to the data stored as part of the fence structure estimation and management system, such as within a fence structure estimation system data repository, can be available by standard mechanisms such as through C, C++, C#, and Java APIs; libraries for accessing files, databases, or other data repositories; through scripting languages such as XML; or through Web servers, FTP servers, or other types of servers providing access to stored data. For example, the fence structure estimation and management system data repository may be implemented as one or more database systems, file systems, memory buffers, or any other technique for storing such information, or any combination of the above, including implementations using distributed computing techniques.

Also, the example fence structure estimation and management system disclosed herein may be implemented in a distributed environment comprising multiple, even heterogeneous, computer systems and networks. For example, in one embodiment, the base plan (parcel of land, for instance), may be provided from an imported document or from a separate engine, the superimposable fence capability may be provided through another engine, the menu(s) of fence materials available for selection with specific materials (specs) for each fence superimposed on a parcel of land base plan may be from another separate engine, the dimensions of materials for such a fence purpose may be provided through yet another engine, a data repository for all such information and inputs may be located in physically different computer systems (or engines), and an interface to allow communication between all such programs/engines may be present in yet another separate engine. In another embodiment, various modules of the fence structure estimation and management system disclosed herein may include a point pattern matching computation engine and may be hosted each on a separate server machine. Different configurations and locations of programs and data are contemplated for use with techniques of any well-known sort and/or as described herein. A variety of distributed computing techniques are appropriate for implementing the components of the illustrated embodiments in a distributed manner including, but not limited to, TCP/IP sockets, RPC, RMI, HTTP, Web Services (XML-RPC, JAX-RPC, SOAP, and the like).

Furthermore, in some embodiments, some or all of the components of the fence structure estimation and management system disclosed herein are implemented or provided in other manners, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), and the like. Some or all of the system components and/or data structures may also be stored (e.g., as software instructions or structured data) on a computer-readable medium, such as a hard disk, a memory, a network, or a portable media article to be read by an appropriate drive or via an appropriate connection. The system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Cloud-based storage and access are certainly contemplated for such computer-based programming as well. Such computer program products may also take other forms in other embodiments. Accordingly, embodiments of this disclosure may be practiced with other computer system configurations.

### BRIEF DESCRIPTION OF THE DRAWINGS

Various exemplary embodiments of the apparatus and structures of this disclosure will be described in detail, with reference to the following figures, wherein:

FIG. 1 is a block diagram of a computing system for practicing embodiments of a fence estimating and planning method presented herein, according to one embodiment.

FIG. 2A is an exemplary aerial view showing an initial parcel of land for fence placement.

FIG. 2B is an aerial view showing the initial plan of FIG. 2A with a fence superimposed thereon with materials and dimensions noted.

FIG. 2C is an exemplary aerial view showing the initial plan of FIGS. 2A and 2B that reflects a change in the materials and dimensions selected by a user.

FIG. 3 is a map of a grid and a fence as in FIGS. 2A, 2B, and 2C obtained by one embodiment of a computer-based fence structure and management estimation system of the disclosure.

FIG. 4 is a flow diagram showing steps in a computer-based method of fence structure estimation and management method that can be performed by the computing system 100 shown in FIG. 1.

### DETAILED DESCRIPTIONS OF THE DRAWINGS AND POTENTIALLY PREFERRED EMBODIMENTS THEREOF

The following descriptions and examples are merely representations of potential embodiments of the present disclosure. The scope of such a disclosure and the breadth thereof in terms of claims following below would be well understood by the ordinarily skilled artisan within this area.

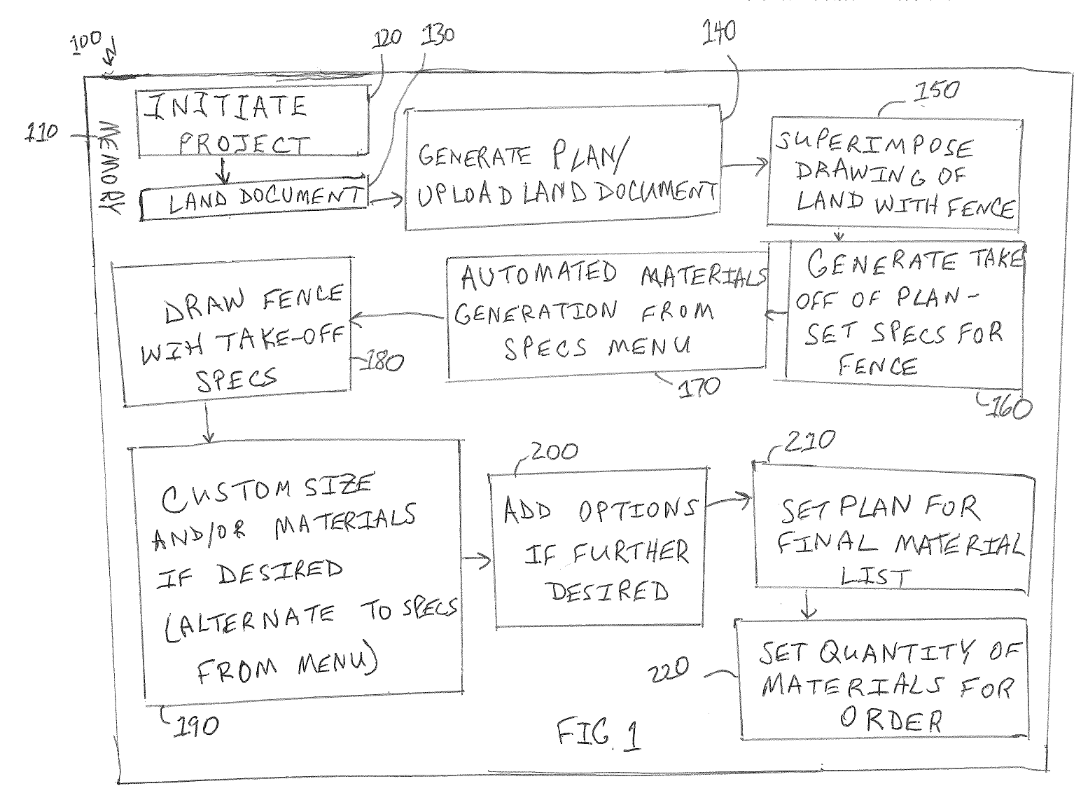

FIG. 1 is an example block diagram of a computing system 100 for practicing embodiments of the fence structure estimating and management method described herein, according to one embodiment.

One or more general purpose or special purpose computing systems may be used to implement the computer-and network-based methods, techniques, and systems for fence structure dimension computation described herein and for practicing embodiments of a fence structure estimation and management system based on such methods, techniques, and/or dimension computations. More specifically, the computing system 100 may comprise one or more distinct computing systems present at distributed locations. In addition, each block shown may represent one or more such blocks as appropriate to a specific embodiment or may be combined with other blocks. Moreover, in one example embodiment, the various components of a fence structure estimation and management system may physically reside on one or more machines, which use standard inter-process communication mechanisms (e.g., TCP/IP) to communicate with each other. Further, the fence structure estimation and management system may be implemented in software, hardware, firmware, or in some combination to achieve the capabilities described herein.

For completeness, one potential system for generating the necessary fence structure materials order is described herein as follows. In the embodiment shown, the computing system 100 comprises a computer memory (“memory”) 110 (including a display, one or more Central Processing Units, Input/Output devices (e.g., keyboard, mouse, joystick, track pad, CRT or LCD display, and the like), other computer-readable media, and network connections, not illustrated). A fence structure estimation and management system 100 is shown residing in the memory 110. In other embodiments, some portion of the contents or some or all of the components of the fence structure estimation and management system 100 may be stored on and/or transmitted over the other computer-readable media (not illustrated). The components of the fence structure estimation and management system 100 preferably execute on one or more CPUs (not illustrated) and generate materials order reports 220, as described herein. Other code or programs (e.g., a Web server, a database management system, and the like) (not illustrated) and potentially other data repositories, such as data repository (not illustrated), also reside in the memory 102, and preferably execute on one or more CPUs (not illustrated).

In a typical embodiment, the fence structure estimation system 100 includes a project initiation stage 120; a land document 130 for uploading; a plan generator (with the uploaded land document) 140, to provide the land document 130 for superimposing of a fence drawing thereon 150. Such a system thus further includes a Take-Off portal 160 to allow for actual designations of materials/structures associated with the superimposed fence 150 that is placed on the land drawing 130. Such materials/structures of the Take-Off portal 160 are provided within a computerized menu 170 either generated automatically or customized 190, if desired. The provision of materials/structures 170 thus allows for the drawing of the fence with such specs in place 180 (with the alternative capability of allowing for customizing of specs thereafter 190). Furthermore, there is present another engine allowing for options to such fence materials/structures 200 as desired by a user (such as ornamentation, differing sizes along the same fence line, etc.). Once all decisions have been made by a user, a final plan is then set 210 by the overall program to then consolidate all information into a materials/structures order 220 to finalize the fence structure estimation and management method/system for the user. Such fence materials/structures may then be delivered for construction thereof.

The final order 220 thus may also include the final rendering of the fence on the land (drawing, for instance, in either an aerial view, three-dimensional view, isometric view, or otherwise). The full report including all materials/structures, drawings, etc., is thus available to the user and may be utilized for such ordering/purchasing directly, thereby simplifying the entire system or method, as noted herein.

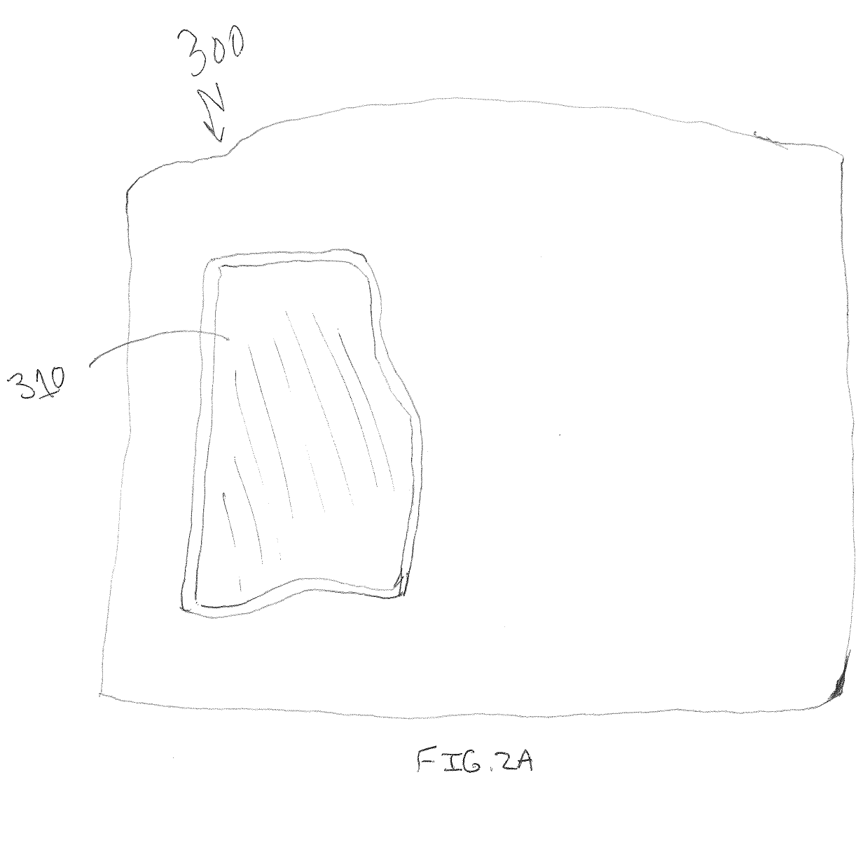

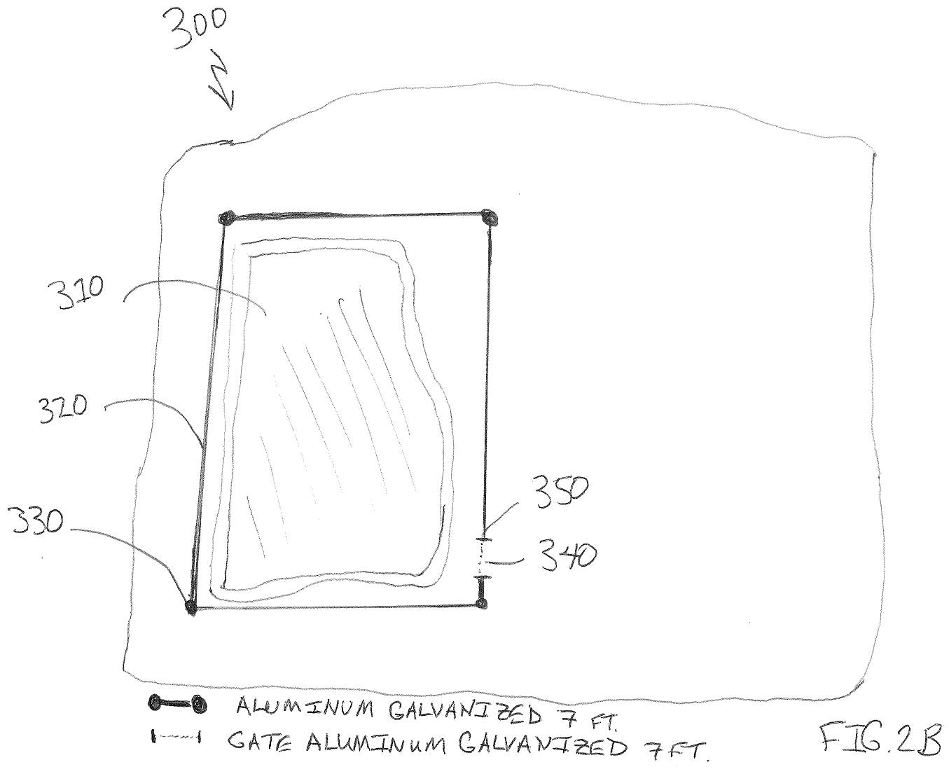

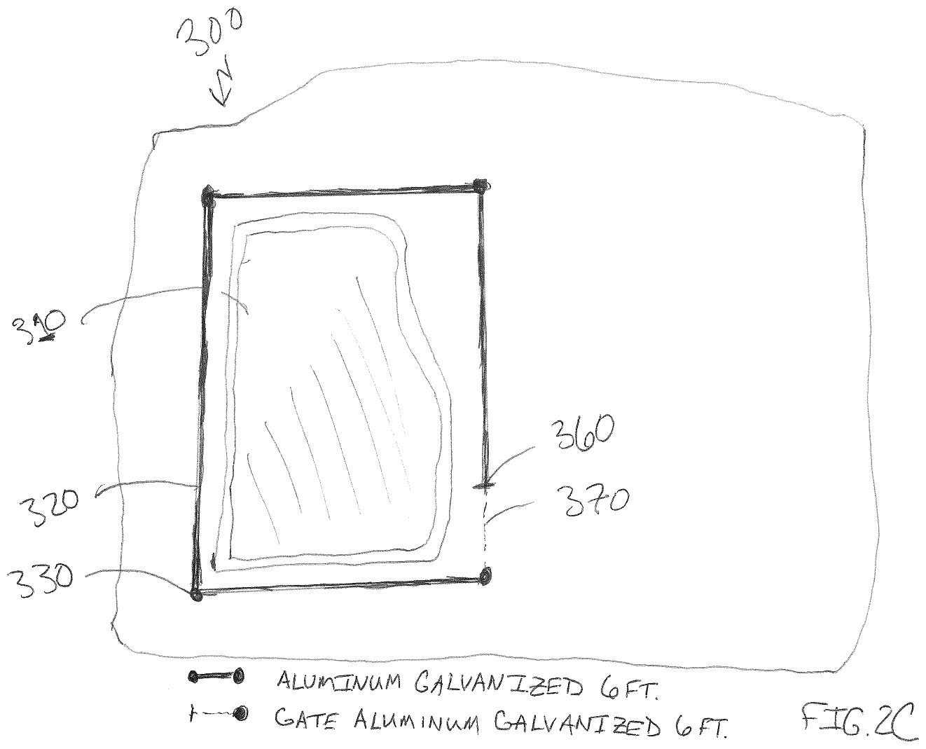

FIG. 2A shows an aerial view of a land document prior to fence superimposition thereon. The parcel 300 shows thereon a pond 310 around which a fence is to be erected. FIG. 2B shows the same aerial view with an initial fence structure 320 superimposed around the pond 310 with connectors 330 at each corner and a gate 340 included for ingress and egress to the pond 310 (with gate connectors 350 present as well). The fence 320 is indicated in a legend thereon as a galvanized aluminum type, seven feet in height. Likewise, the gate 340 is indicated, material-wise, in the same manner. FIG. 2C thus shows a changed structure with the same pond 310 and fence 320, with the materials changed to galvanized aluminum at 6 feet in height (and the gate 340, altered in terms of length and dimension, but to the same height). The total length of each side of the fence components (sides) may be indicated as well, same as that for the gate. Additionally, the system may indicate the distance such a fence is present from the land borders at any point, if desired, ostensibly to provide an overall disposition of the fence 320 for placement on the parcel 300.

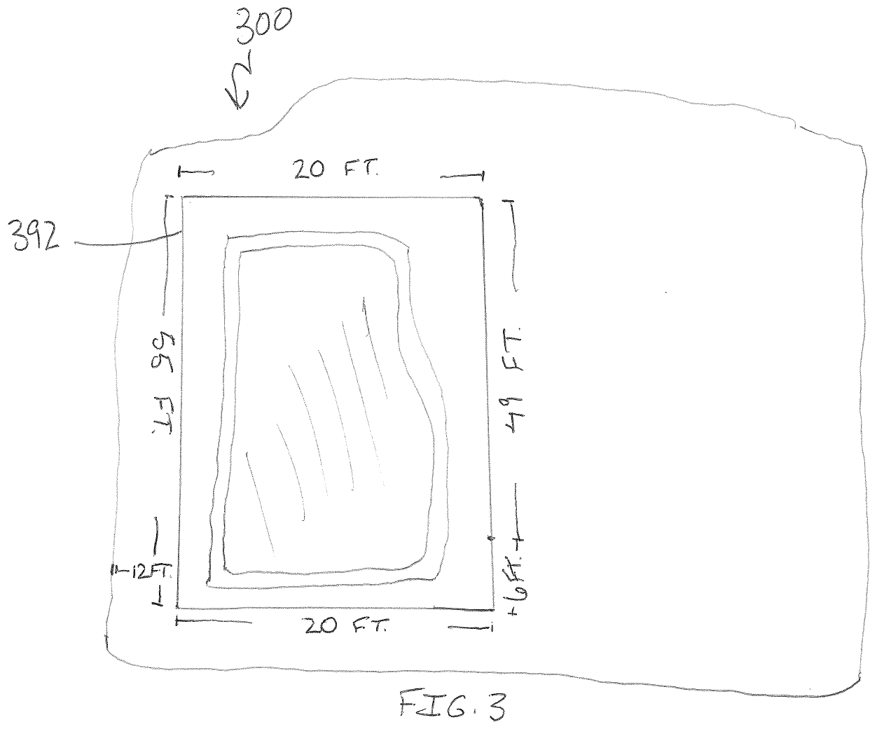

FIG. 3 thus provides the land document parcel 300 with the pond 310 and the fence 320 and gate 340 with length dimensions (55 ft.×20 ft., with a 6 ft. measure for the gate) and a distance (12 ft.) from the border. Combined with the materials/structures indicated in FIG. 2B, a final structural estimate may then be generated and an order may be provided.

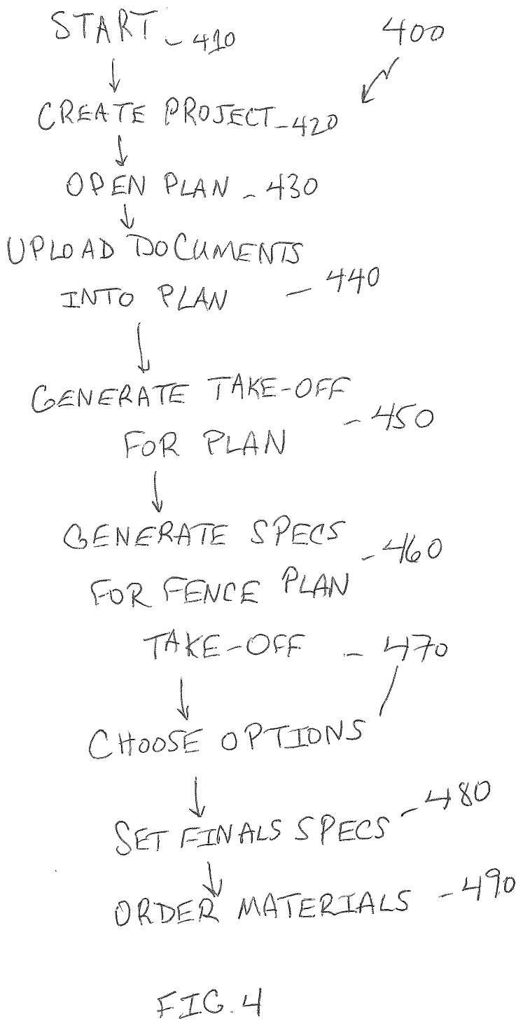

FIG. 4 provides a flow chart for the overall system/method 400. The fence structure estimation and management system 400 thus has a start 410 wherein a menu is provided a user to then generate a fence structure estimation and management system project 420. Such a project 420 may then be provided a name and a plan may then be opened 430 under such a name (for identification purposes, at least). Once opened, the user may then upload any documentation needed 440 into the plan (including, as noted above, a specific parcel of land rendering with measurements, etc., for facilitating actual fence placement and dimensions through the automated computer system). Once the documentation is uploaded 440 within the plan, the user may then access a Take-Off program 450 to allow for actual placement of fence representations on the uploaded document and then allow for automated generation of specs related to selected fence structures and dimensions associated therewith 460. As noted above, such a step allows the user to access any number of different fence structures and materials to determine which may be best for such a desired final structure (including, without limitation, metal types, wood types, gauge measures, connections, connection covers, heights, weights, colors, etc.). To that end, such a user may thus undertake customization of such selections as well as options 470 that are generally not available through a standard fence structure materials menu. Once such options/alternatives have been considered and selected 470, the user may then decide on a final specification 480 for his/her fence structure (in terms of materials, dimensions, etc.) and a final order for such materials, etc., 490 may then be undertaken. All of this is provided through a computerized system that allows for direct and immediate selection capability from menus inputted therein. If done manually, such a system would take any number of hours, certainly, and such time consumption would be detrimental to such a construction method, particularly if the user/customer requires instant or at least very quick work completed. The ability to view such final maps with specs indicating the extent not only of the materials to be utilized, but the costs needed to purchase the same, has heretofore been unexplored and provides much more than the previous method of, again, manual considerations and lengthy report generations.

From the foregoing it will be appreciated that, although specific embodiments have been described herein for purposes of illustration, various modifications may be made without deviating from the spirit and scope of the present disclosure.

In conclusion, the presently disclosed system and method is the only software platform designed for and provided for the fence industry that allows users to virtually draw fence lines on blueprints. It understands how fence lines connect to terminal posts (end, corner, gate, etc.) and further comprehends all of the components required for each gate type and fence type in the industry today. The disclosed system and method further allow user unlimited customization to suit their unique needs or customer's specifications. Additionally, the disclosed system and method was created by fence industry professionals who searched for a software program with the above-described capabilities for many years. After finding no viable solution, these fence professionals were inspired to finally create a software platform for the fence industry including the full disclosures provided below. Although there is an abundance of software that allows users to draw on plans and create take-offs, there are none that cater to the fence industry specifically and certainly not to the degree as disclosed and described herein. Basically, no prior fence industry design and manufacture software programs understand the detailed requirements noted above for the disclosed system and method. The lack of dynamic understanding of the fence industry is noticeable with the lack of actual disclosure of any overarching capabilities in a single platform software product within the current state of such an art. Thus, the facilitation and complete deployment of such a single platform system and method as herein disclosed and described is a significant and important improvement within the fence design and manufacturing software program industry.

Having described the disclosure in detail it is obvious that one skilled in the art will be able to make variations and modifications thereto without departing from the scope of the present invention. Accordingly, the scope of the present disclosure should be determined only by the claims appended hereto.

1. An energy storage device comprising an anode, a cathode, at least one separator present between said anode and said cathode, an electrolyte, at least one thin film current collector in contact with at least one of said anode and said cathode, and at least one tab attached to said at least one thin film current collector, wherein
a. said at least one tab is attached to said collector through a connection means;
b. said connection means exhibits electrical contact with an exposed surface of said at least one tab and said at least one thin film current collector;
c. either of said anode or said cathode are interposed between at least a portion of said thin at least one film current collector and said at least one separator;
d. said at least one film current collector comprises a conductive material coated on a non-conductive material substrate;
e. said at least one film current collector stops conducting at the point of contact of a short circuit at the operating voltage of said energy storage device; and
f. said operating voltage is at least 2.0 volts.

2. The energy storage device of claim 1, wherein said connection means is selected from the group consisting of welds, tape, staples, interposing metal strips, z-folded metal strips, conductive adhesives and clamps.

3. The device of claim 2, wherein the connection means consists of between 2 and 50 connections distributed throughout said at least one film current collector so as to allow uniform current flow from the electrode materials to the tabs.

4. The device of claim 1, wherein said at least one film current collector is folded to allow face-to-face contact between the opposing sides of said at least one film current collector.

5. The device of claim 1, wherein said at least one separator is polymeric, nonwoven, fabric or ceramic.

6. The device of claim 1, wherein said non-conductive material substrate is a polymer film.

7. The device of claim 1, wherein said electrolyte is a flammable organic electrolyte.
